(19) United States
(12) Patent Application Publication
(10) Pub. No.: US 2005/0102468 A1
(43) Pub. Date: May 12, 2005

(54) Methods and systems for coupling multiple initiators to SATA storage devices

(76) Inventors: William P. Delaney, Wichita, KS (US); William Brant, Boulder, CO (US)

Correspondence Address: LSI LOGIC CORPORATION, 1621 BARBER LANE, MS: D-106, MILPITAS, CA, 95035, US

(21) Appl. No.: 10/702,884

(22) Filed: Nov. 6, 2003

(51) Int. Cl. G06F 12/00

(52) U.S. Cl. 711/114

(57) ABSTRACT

An interposer (port selector) and associated systems and methods coupling an SATA storage device to multiple, concurrently operable, storage controllers (multiple initiators). The interposer allows automatic selection of one of a plurality of a storage controllers for active coupling to the corresponding storage device. Features of the interposer and its operation detect automatically which storage controller presently requires coupling to the device and, transparently with respect to both the storage controllers and a storage device, effectuate the desired coupling.

### BACKGROUND OF THE INVENTION

1. Field of the Invention

The invention relates to storage devices coupled to multiple initiators and more specifically relates to an interposer for coupling serial ATA devices to multiple storage controllers.

2. Discussion of Related Art

Computer storage subsystems often utilize multiple storage devices within the subsystem for improving reliability and/or performance of the storage system. Reliability is enhanced in storage subsystems utilizing multiple storage devices by generation and storage of redundant information on storage devices within the storage subsystem. For example, RAID storage subsystems (Redundant Array of Independent Drives) generate and store redundant information on storage devices of the storage subsystem so that failure of a single storage devices (e.g., disk drive) allows continued operation of the subsystem and prevents loss of data. A variety of RAID management techniques known as RAID “levels” are well known to those of ordinary skill in the art to provide such redundancy. Performance of a storage subsystem may be enhanced by utilizing multiple storage devices through techniques known as striping. In essence, striping distributes data over multiple storage devices so that a single read or write I/O request may utilize data transfer bandwidth of multiple, simultaneously operable, storage devices. I/O requests so processed utilizing multiple, concurrently operable storage devices complete data transfer more rapidly by utilizing the parallel bandwidth available from multiple storage devices as compared to the time to complete the operation from a single storage device.

To further enhance both reliability and performance in storage subsystems it is also known to provide multiple storage controllers within such a storage subsystem. Multiple controllers may be utilized to enhance reliability by permitting continued storage system operation in the event of a storage controller failure. A second controller may assume responsibility for the I/O operations of the failed controller. In addition, multiple storage controllers may be utilized to enhance performance of the storage subsystem by utilizing processing capabilities of multiple storage controllers for processing I/O operations in parallel.

In such a multiple controller storage subsystem, each controller typically uses its own communication path to the storage devices—or even multiple redundant communication paths. Hence, it is common to utilize storage devices generally configured to permit such multiple controllers (i.e., multiple initiators) to access the storage device substantially concurrently.

To enable such high performance storage subsystems having multiple controllers each coupled to each storage device and including the capability of concurrent access to storage devices by multiple storage controllers, storage devices and controllers supporting SCSI protocols and communication media are often utilized. SCSI protocols and communication media inherently permit such multiple concurrent access between storage controllers and storage devices. Utilization of SCSI protocols and communication media tends to increase cost of the storage subsystem as compared to other, lower cost, mass market storage devices supporting other protocols and communication media generally available in the market. For example, ATA storage devices tend to be substantially lower cost as compared to SCSI storage devices providing similar storage capacity. In particular, serial ATA (SATA) storage devices provide similar storage capacity and similar performance by utilizing high speed serial interfacing techniques to couple the storage controllers to SATA storage devices. However, ATA and SATA devices do not inherently support multiple controllers concurrently accessing the storage device.

The SATA Working Group is a trade association that has developed, maintains and publishes specifications for SATA device interfacing standards. SATA Working Group has also produced specifications for a multiplexing device referred to as a Port Selector for permitting enhanced operation of SATA storage devices by permitting multiple, concurrently operating storage controllers to access an SATA storage device. Specifications for SATA devices and for an SATA Port selector are publicly available at http://www.serialata.org.

The Port Selector specification suggests such a design implemented as an electronic signal multiplexer where the selection input of the multiplexer determines which of multiple storage controllers is presently coupled to the storage device. In general, the specification calls for a multiplexer device (also referred to herein as a port selector or interposer) be provided as an electronic circuit card coupled between the multiple storage controllers and a corresponding SATA storage device. The specification suggests that port selection may be provided by either of two specified approaches: protocol based port selection or sideband port selection. In protocol based port selection, each host storage controller may generate out-of-band signals directed to the port selector instructing the port selector to select the corresponding storage controller as the presently active controller coupled to the SATA storage device. Sideband port selection merely specifies that other protocols outside the scope of SATA standards may be used for selecting the presently active storage controller for coupling to the storage device.

A problem with protocol based port selection arises in that the storage controllers must be aware of the presence of the interposer (port selector) so that they may properly direct the port selector to select the desired coupling to a storage controller. Such a requirement imposes changes on existing storage controller architectures and operation. An existing storage controller architecture adapted to control SATA devices must add support for control of the port selector (interposer) if multiple storage controller may concurrently access the devices.

It is evident from the above discussion that a need access for an improved interposer architecture for coupling SATA storage devices to multiple storage controllers in a manner that is transparent to both the storage controllers and attached storage devices.

### SUMMARY OF THE INVENTION

The present invention solves the above and other problems, thereby advancing the state of the useful arts, by providing methods and systems that automatically select an active port for coupling an SATA storage device to one of multiple storage controllers and that do so in a manner transparent to both the controllers and the storage devices. Features and aspects hereof provide and interposer circuit and methods for operation of an interposer electronically positioned between signals exchanged between SATA devices and corresponding storage controllers. Features and aspects of such an interposer include logic to automatically detect which of multiple storage controllers should be selected as the presently active controller coupled to the SATA storage device and to couple the appropriate controller thereto thus permitting multiple initiators to actively and concurrently submit commands to a storage device in an independent and uncoordinated fashion by comparison with prior techniques the required careful coordination.

One feature hereof therefore provides an interposer for coupling multiple active storage controllers to a SATA storage device, the interposer comprising: a multiplexer for selectively coupling SATA signals between the SATA storage devices and a selected storage controller of the multiple active storage controller; and control logic coupled to the multiplexer for automatically controlling the multiplexer to select the selected storage controller.

Another aspect hereof further provides that the multiplexer further comprises: a receive signal multiplexer for selectively coupling a transmit signal from the selected storage controller to a receive signal path of the SATA storage device; and a transmit signal multiplexer for selectively coupling a transmit signal from the SATA storage device to a receive signal path of the selected storage controller.

Another aspect hereof further provides that the control logic further comprises: an idle signal generator for generating an idle signal, such that the transmit signal multiplexer is operable to selectively couple the idle signal generator to all non-selected controllers of the multiple active storage controller to apply the idle signal to each of the non-selected controllers.

Another aspect hereof further provides that the idle generator is adapted to generate ATA SYNC primitives to the non-selected controllers.

Another aspect hereof further provides that the control logic further comprises: a detector for detecting the initiation of a transfer by a requesting controller of the multiple active storage controller, such that the control logic is operable to select the requesting controller as the selected controller in response to detection of initiation of a transfer by the requesting controller.

Another aspect hereof further provides buffers associated with each controller of the multiple active storage controllers and with the SATA storage device and coupled to the control logic for maintaining alignment of transferred information in conjunction with selection of the multiplexer by the control logic.

Another feature hereof provides an interposer for selectively coupling a SATA storage device and a plurality of controllers, the interposer comprising: detection means for detecting a request by a select controller of the plurality of controller to initiate a transfer to the storage device; and multiplexing means responsive to the detection means for coupling the select controller to the storage device.

Another aspect hereof further provides that the storage device has a transmit signal and a receive signal and such that each controller of the plurality of controllers has a transmit signal and a receive signal, and such that the multiplexing means further comprises: means for coupling the transmit signal of the select controller to the receive signal of the storage device; and means for coupling the receive signal of the select controller to the transmit signal of the storage device.

Another aspect hereof further provides idle generation means for generating SATA SYNC primitives, such that the multiplexing means further comprises: means for coupling the receive signal of each non-selected controller of the plurality of controllers to the idle generation means.

Another aspect hereof further provides that the idle generation means further comprises: a plurality of SATA SYNC primitive generators each associated with a corresponding controller of the plurality of controllers.

Another aspect hereof further provides that the detection means detects the request based on in-band SATA information from the select controller.

Another feature hereof provides a storage system comprising: a plurality of storage controllers; a SATA storage device; and an interposer coupled between the SATA storage device and each of the plurality of storage controllers for selectively coupling a selected controller of the plurality of storage controllers to the SATA storage device such that the interposer is operable to select the selected controller based solely on in-band SATA information generated by the plurality of storage controllers.

Another feature hereof provides a method for selectively coupling multiple active storage controllers to a SATA device comprising the steps of: a) detecting a request to start a transfer between a requesting controller of the plurality of storage controllers and the SATA storage device; b) coupling the requesting controller to the SATA device; and c) transmitting idle information to the plurality of storage controllers other than the requesting controller.

### BRIEF DESCRIPTION OF THE DRAWINGS

FIG. 1 is a block diagram showing a port selector as presently known in the art.

FIG. 2 is a block diagram of an exemplary interposer embodying features and aspects hereof.

FIG. 3 is a block diagram providing additional details of an exemplary interposer embodying features and aspects hereof.

FIG. 4 is a state machine diagram describing operation of an exemplary interposer embodying features and aspects hereof.

FIG. 5 is a flowchart describing operation of an exemplary interposer embodying features and aspects hereof.

### DETAILED DESCRIPTION OF THE DRAWINGS

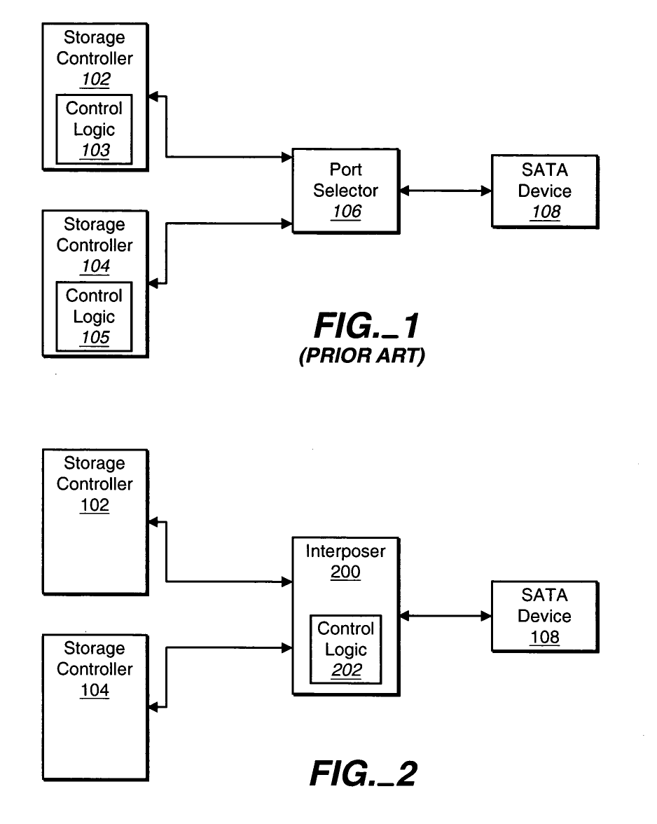

FIG. 1 is a block diagram showing a port selector as suggested by the SATA Port Selector specifications and, hence, as presently known in the art. Port selector 106 is coupled to SATA storage device 108 and to each of multiple storage controllers 102 and 104. Port selector 106 functions, in essence, as a multiplexer capable of selectively coupling one of storage controllers 102 or 104 to SATA storage device 108. Control logic 103 and 105 within storage controllers 102 and 104, respectively, generate out-of-band signal information, as discussed above, intercepted by port selector 106 to thereby control selective coupling of the storage controllers 102 and 104 to SATA storage device 108. As noted above, and as shown in FIG. 1, storage controllers 102 and 104 must include specific additional control logic 103 and 105, respectively, to operate the selective features of port selector 106 by generation and transmission of the out-of-band messages. Such a requirement imposes a burden on existing storage controller architectures such as that existing control features within existing storage controllers will require modification to incorporate specific control logic elements 103 and 105 to provide the out-of-band signaling required by port selector 106. Therefore, such known port selection features are not transparent to storage controller 102 and 104 but rather require modification of existing controller designs.

FIG. 2 is a block diagram showing an improved interposer 200 providing port selection features with control logic 202 integrated therein. Interposer 200 with integrated control logic 202 provides a similar port selection capability to those described above with respect to FIG. 1 but provides such features in a manner that is transparent to storage controllers 102 and 104. Those of ordinary skill in the art will readily recognize that any number of storage controllers maybe selectively coupled to SATA storage device 108 through interposer 200. FIG. 2 is therefore merely intended as representative of a common configuration wherein dual active controllers (102 and 104) are to be coupled to a shared SATA storage device 108.

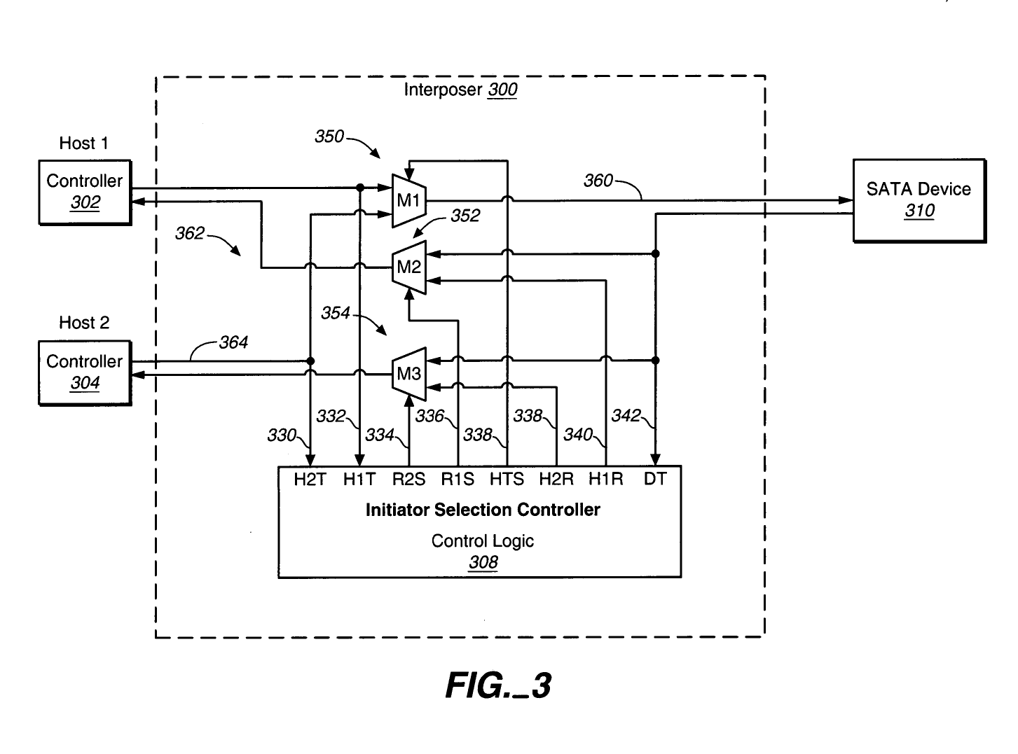

FIG. 3 is a block diagram providing additional details of an exemplary embodiment of features and aspects hereof. Interposer 300 may include multiplexers M1 350, and M2 352, and M3 354. Control logic 308 generates selection signals HTS 338, R1S 336, and R2S 334, coupled to a corresponding selection input of multiplexers M1 350, and M2 352, and M3 354, respectively. These multiplexer devices may be used to control connectivity between the storage controllers 302 and 304 and the storage device 310. In particular, multiplexer M1 350 allows the transmit data signal from either controller 302 or controller 304 to be coupled to the received signal path of the storage device 310. Control logic 308, as discussed further herein below, determines which controller should be presently selected as active and thereby coupled to storage device 310. Selection a signal HTS 338 is generated by control logic 308 and coupled to the selection input of multiplexer M1 350 to select a transmit signal from one of controllers 302 or 304 to be applied to the receive input of storage device 310.

In like manner, multiplexer M2 352 and M3 354 may be used to select a source signal from multiple signals that may be applied to the receive data signal path of either controller 302 and controller 304, respectively. Selection signal R1S 336 may be generated by control logic 308 and applied to a selection input signal of multiplexer M2 352. Selection signal R2S 334 may be generated by control logic 308 and applied to a selection input signal of multiplexer M3 354.

More specifically, multiplexer M1 350 receives signal H1T 332 (the transmit signal from controller 302) as a first input signal and H2T 330 (the transmit signal from controller 304) as a second input to multiplexer M1 350. Based on the selection signal HTS 338 generated by control logic 308, either signal H1T 332 or signal H2T 330 is selected for application to storage device 310 via signal path 360. M2 352 receives a transmit signal DT from storage device 310 on path 344 as one input and H1T 342 as a second input generated from control logic 308. H1T 342 is a signal generated by control logic 308 to provide SYNC primitives in accord with SATA standards during periods in which controller 302 is not the selected controller coupled to the storage deice 310. Based on selection input signal R1S 336, multiplexer M2 352 will select either DT 344 or H1T 342 for application to the receive signal path 362 of controller 302. Similarly, multiplexer M3 354 receives device transmit signal 344 as a first input and H2R 340, generated by control logic 308, as a second input. H2R 340 is a signal generated by control logic 308 to provide SYNC primitives in accord with SATA standards during periods in which controller 304 is not the selected controller coupled to the storage device 310. Based on selection signal R2S 334 generated by control logic 308, multiplexer M3 354 will apply either DT 344 or H2R 340 to receive signal path 364 of controller 304.

H1T 342 and H2R 340 represent signals generated by control logic 308 for application to a presently non-selected controller while the selected controller receives the actual data transmission (DT 344) from storage device 310. Essentially, when controller 302 is presently selected as the active controller by control logic 308, DT 344 is coupled to receive signal 362 of controller 302 and H1T 332 is coupled to receive signal 360 of storage device 310. When controller 304 is presently selected as the active controller, DT 344 is coupled to receive signal 364 of controller 304 and transmit signal H2T 330 of controller 304 is applied to receive signal 360 of storage device 310. The transmit signal of one of the multiple controller (i.e., H1T 332 or H2T 330) is always coupled to the receive signal path 360 of the storage device 310 so that the device always perceives connection to some controller. The receive signal corresponding to the controller presently having its transmit line coupled to the storage device is preferably coupled through M2 or M3 to the transmit signal DT 344 of the storage device 310. However, the receive signal of all controllers (i.e., both 362 and 364) may be simultaneously coupled to the corresponding sync generation signal path (H1R and H2R) if required for a particular application.

A more complete description of signals received and generated by control logic 308 may be as follows:
H2T (Host 2 Transmit): This input to the interposer is driven by controller 304's SATA transmit signal. It allows the interposer to monitor the transmissions of controller 304 (also referred to herein as host 2), and take appropriate action to manage the sharing of the storage device 310.
H1T (Host 1 Transmit): This input to the interposer is driven by controller 302's SATA Transmit signal. It allows the interposer to monitor the transmissions of controller 302 (also referred to herein as host 2), and take appropriate action to manage the sharing of the storage device 310.
R2S (Receive 2 Select): This output from the interposer controls the selection state of multiplexer M3 354, and thus determines the source of the Receive signal for controller 304. The two possible source values are the storage device's (310) transmit signal, or the interposer's H2R output signal.
R1S (Receive 1 Select): This output from the interposer controls the selection state of multiplexer M2 352, and thus determines the source of the Receive signal for controller 302. The two possible source values are the storage device's (310) transmit signal, or the interposer's H1T output signal.
HTS (Host Transmit Select): This output from the interposer controls the selection state of multiplexer M1 350, and thus determines the source of the Receive signal for the storage device 310. The two possible source values are controller 302's Transmit signal, or controller 304's transmit signal.
H2R (Host 2 Receive): This output from the interposer provides the signal to be routed to controller 304's Receive line when the storage device 310 is physically connected to controller 302. In such cases, the interposer will actually determine the primitives to be delivered to controller 302 to ensure that it waits passively for the storage device 310 to be attached to it, instead of to controller 304.
H1R (Host 1 Receive): This output from the interposer provides the signal to be routed to controller 302's Receive line when the storage device 310 is physically connected to controller 304. In such cases, the interposer will actually determine the primitives to be delivered to controller 304 to ensure that it waits passively for the storage device 310 to be attached to it, instead of to controller 302.
DT (Drive Transmit): This input to the interposer is fed from the storage device's (310) transmit signal. It allows the interposer to monitor transmissions from the storage device 310 to the controller that is currently connected (via multiplexer selections) to the storage device 310.

Those of ordinary skill in the art will recognize that multiplexer configurations shown in FIG. 3 are representative of the functions performed to selectively couple a selected controller of multiple controllers to a common storage device. It is necessary to account for design requirements to maintain a seamless transmission stream at the output of the multiplexer as required by the SATA interface standards. However, each controller 302 and 304 may operate in a different clock domain and interposer 300 may operate in yet another clock domain. It is almost a certainty that phase relationship and alignment problems will arise if simple multiplexers are used to switch signal paths directly between a selected controller and the storage device. Consequently, in the best known mode of implementing features and aspects hereof, a more sophisticated multiplexing scheme is required to ensure that a switch from one signal source to another signal source occurs without disrupting transmission word alignment as required by SATA standards. Such a requirement is applicable to transmissions in both directions (i.e., from the selected controller to the device and from the device to the selected controller). The best known mode of implementing features and aspects hereof therefore includes buffering and alignment features within control logic 308 such that all signals exchanged between the storage device 310 and any of the multiple storage controllers (302 and 304) may be aligned as required for the corresponding clock domain. As used herein, “multiplexer” or “multiplexing” refers to any structure or method that effectuates the desired switching of signals in a manner compliant with signaling properties of the SATA standards, including, for example, simple multiplexers as well as the more sophisticated embodiment both discussed above.

As a matter of design choice, one implementation for assuring such word alignment provides that control logic 308 maintains a one word (i.e., 40 bit) buffer for each of the various receive line signal paths associated with the interposer 300 (i.e., receive paths 360, 362 and 364). When switching between transmission sources to be applied to a corresponding received path, the receive signal buffer is first filled with successive transmission words from the selected source and is only then shifted into the actual stream of the receive signal only when the previous transmission has been completed. Although such a design introduces of latency of, at most, 40 bit times, such an effect has a negligible impact on performance. In addition, in order to avoid potential received data discrepancies, the internal mechanisms of control logic 308 may also include the ability to replace a given transmission word with its equivalent, opposite-RD-polarity variant in accordance with SATA standards. Such designs and design choices are well known to those of ordinary skill in the art and are discussed in SATA specifications. Those of ordinary skill in the art will recognize that FIG. 3 is intended merely as representative of numerous equivalent structures to provide automated selection among a plurality of active controllers for coupling to a shared storage device.

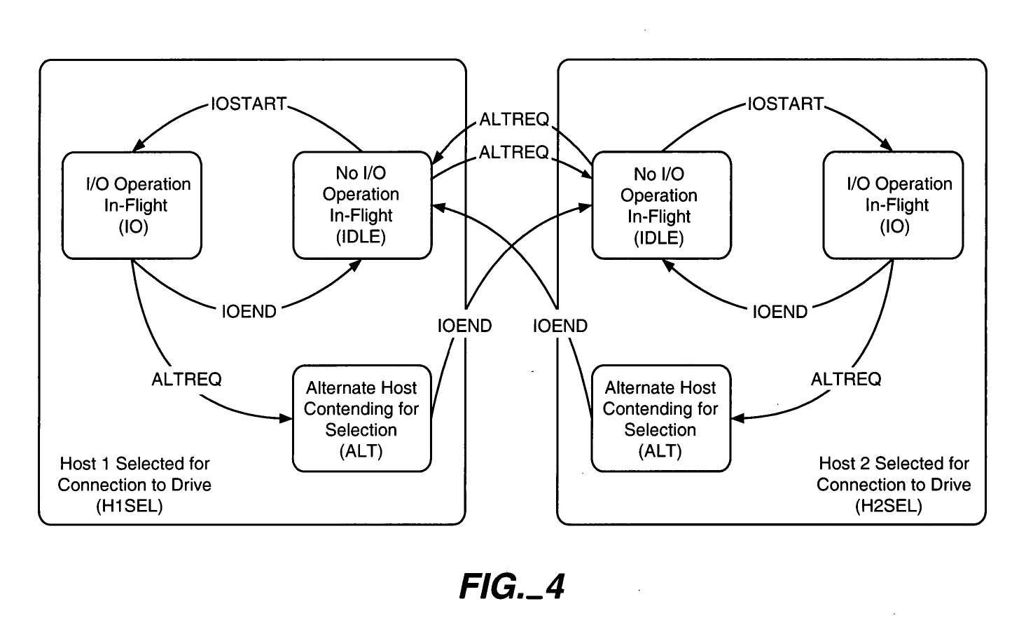

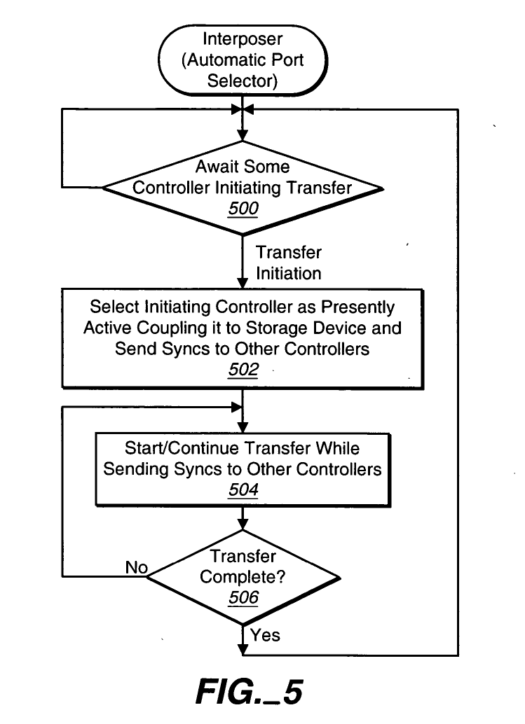

FIGS. 4 and 5 provide additional details of the operation of an interposer in accordance with features and aspects hereof. FIG. 5 is a flowchart describing simplified operation of the interposer. Element 500 is operable to await detection of some controller requesting initiation of a transfer to the storage device. SATA protocol standard requires that the sender of any framed information sequence (FIS) first arbitrate for the link by repeatedly transmitting transmitter ready primitives (X_RDY). The initiating sender then waits for receipt of a receiver ready primitive (R_RDY) before beginning transmission of the FIS. A requesting controller therefore begins sending X_RDY primitives on its transmit line such that the interposer may thereby detect the desire of the corresponding controller to initiate a transfer to the storage device. As noted above this aspect hereof permits the interposer to detect a need for selecting the requesting controller without requiring the controller to generate out-of-band signals as suggested by the SATA Port Selector specification. Rather, in accordance with features and aspects hereof, normal information exchanges initiated by the controller are recognized by the control logic of the interposer to detect a request to initiate a transfer by a controller. Such detection may also be referred to herein as in-band information as distinct from the out-of-band information requirements of the SATA Port Selector standard.

Upon detection of such a request to initiate a transfer by element 500, element 502 is operable to select the requesting controller as the presently selected or presently active controller. This process couples the transmit and receive signal paths of the selected controller to the corresponding receive and transmit signal paths of the storage device. As noted above, such coupling may be accomplished through simple multiplexing schemes or through more robust multiplexing schemes wherein buffering features of the interposer help assure proper alignment of the information exchanged between a selected controller and the data storage device (i.e., alignment through multiple, distinct clock domains). Element 504 is then operable to start (or continue) the requested transfer between the selected controller and the SATA storage device. In addition, element 504 is further operable to generate idle sequences (SYNC primitives) for application to receive signal paths of other, non-selected controllers. Providing such idle sequences (SYNC primitives) to non-selected controllers permits each controller to maintain the perception that it is directly connected to the SATA storage device.

While idle information is transmitted to other non-selected controllers, the selected controller and storage device interact according to standard SATA protocols to exchange desired information. Element 506 monitors the transfer between he selected controller an the SATA storage device to detect completion of the transmission. The interposer may detect completion of the exchange in accordance with the SATA specifications by detecting a framed information sequence having a type “Register—Device to Host” in which the Status register field has both the BSY and DRQ bits set to zero. Such an indication, in accordance with SATA standard, in-band exchanges indicates completion of the previously initiated request. Processing continues with elements 504 and 506 iteratively operable until completion is detected by element 506. Upon detection of completion of the previously initiated transfer, processing continues by looping back to element 500 to await a controller requesting initiation of a transfer to the storage device. As noted above, the presently coupled controller may remain coupled to the storage device until another request to initiate a transfer is detected above by element 500. Element 502 will then select the next appropriate controller for coupling to the storage device and couple other controller receive signals to a corresponding SYNC generation signal. Where multiple controllers substantially simultaneously request initiation of a transfer, well known arbitration techniques may be employed to determine which requesting controller is next serviced.

The flowchart of FIG. 5 is intended merely to describe general operation of an interposer operable in accordance with features and aspects hereof. As a matter of design choice, one possible implementation of such a logic is operable in accordance with a state machine as shown in FIG. 4. Such state machine models of logic functions are well known to those of ordinary skill in the art and readily implemented into custom circuits through widely available design tools.

As shown in the state machine diagram of FIG. 4, two active controllers are presumed to be present and are referred to as “Host 1” and “Host 2.” In one aspect hereof, at all times, either the Host 1 or Host 2 controller is selected for connection to the SATA storage device. As a matter of design choice, at power on initialization of the interposer, either Host 1 or Host 2 may be selected as presently coupled to the storage device. When the presently non-selected controller indicates a desire to initiate a transfer with the storage device, an event signal designated as ALTREQ may be detected to cause an appropriate state transition in the state machine model. When a requested transfer is actually initiated by a selected controller to the storage device, an IOSTART event is signaled to cause appropriate state transitions. Further, completion of such an initiated exchange, when detected, signals an IOEND event to cause appropriate state transitions in the state machine model. The following state descriptions and event descriptions provide a more accurate and detailed presentation of such exemplary state machine model. Such a state machine model description may be readily translated to corresponding circuit designs by those of ordinary skill in the art using readily available design tools.

| State Name | Description | Actions/Conditions/etc. |
|---|---|---|
| H1SEL:IDLE | The multiplexers are | HTS selects Host 1's Transmit line. |
| | configured so that Host 1 is | R1S selects Drive's Transmit line. |
| | connected to the drive. No I/O | R2S selects H2R output of the |
| | operation is currently in- | interposer. |
| | flight. Host 2 is not | Interposer generates SYNC |
| | contending for access to the | primitives on its H2R output. |
| | drive. | |
| H1SEL:IO | The multiplexers are | Same as H1SEL:IDLE. |
| | configured so that Host 1 is | |
| | connected to the drive. An I/O | |
| | operation is currently in-flight | |
| | between Host 1 and the Drive. | |
| | Host 2 is not contending for | |
| | access to the drive. | |
| H1SEL:ALT | The multiplexers are | Same as H1SEL:IDLE. Note that |
| | configured so that Host 1 is | by generating only SYNC |
| | connected to the drive. An I/O | primitives on the H2R output, the |
| | operation is currently in-flight | interposer ensures that Host 2 does |
| | between Host 1 and the Drive. | not see any R_RDY primitive that |
| | Host 2 is actively contending | would allow it to proceed with |
| | for access to the drive (i.e. it | transmission. This is the primary |
| | is transmitting X_RDY | mechanism by which the interposer |
| | primitives). | forces the non-selected host to wait |
| | | until an in-flight I/O operation is |
| | | complete before proceeding with its |
| | | request to the drive. |
| H2SEL:IDLE | The multiplexers are | HTS selects Host 2's Transmit line. |
| | configured so that Host 2 is | R2S selects Drive's Transmit line. |
| | connected to the drive. No I/O | R1S selects H1R output of the |
| | operation is currently in- | interposer. |
| | flight. Host 1 is not | Interposer generates SYNC |
| | contending for access to the | primitives on its H1R output. |
| | drive. | |
| H2SEL:IO | The multiplexers are | Same as H2SEL:IDLE. |
| | configured so that Host 2 is | |
| | connected to the drive. An I/O | |
| | operation is currently in-flight | |
| | between Host 2 and the Drive. | |
| | Host 1 is not contending for | |
| | access to the drive. | |
| H2SEL:ALT | The multiplexers are | Same as H2SEL:IDLE. Note that |
| | configured so that Host 2 is | by generating only SYNC |
| | connected to the drive. An I/O | primitives on the H1R output, the |
| | operation is currently in-flight | interposer ensures that Host 1 does |
| | between Host 2 and the Drive. | not see any R_RDY primitive that |
| | Host 1 is actively contending | would allow it to proceed with |
| | for access to the drive (i.e. it | transmission. This is the primary |
| | is transmitting X_RDY | mechanism by which the interposer |
| | primitives). | forces the non-selected host to wait |
| | | until an in-flight I/O operation is |
| | | complete before proceeding with its |
| | | request to the drive. |

The following table describes the events that cause state transitions within the state diagram shown in FIG. 4 and described in the above table. Note that the diagram is symmetric, so the same events can occur in either of the two “major states” (i.e. H1SEL and H2SEL).

| Event | |
|---|---|
| Name | Description |
| IOSTART | This event occurs when the interposer detects that the selected |
| | host has started an I/O operation. The detection is |
| | accomplished by the interposer monitoring the FIS |
| | traffic from the selected host to the drive. When a |
| | “Register - Host to Device” FIS is seen, |
| | it indicates that an I/O is being started by the host. |
| IOEND | This event occurs when the interposer detects that an in-flight |
| | I/O operation between the selected host and the drive has |
| | completed. The detection is accomplished by the interposer |
| | monitoring the FIS traffic from the drive to the selected host. |
| | When a “Register - Device to Host” FIS is seen, and |
| | the Status register field in the FIS has its BSY and DRQ bits |
| | set to zero, it indicates that the in-flight I/O has completed. |
| ALTREQ | This event occurs when the non-selected host attempts to |
| | communicate with the drive. The detection is accomplished |
| | by the interposer monitoring the link signals on the |
| | non-selected host's Transmit line. When the interposer detects |
| | that the non-selected host is transmitting X_RDY |
| | primitives, it indicates that the non-selected |
| | host is attempting to communicate with the drive. |

Those of ordinary skill in the art will recognize a wide variety of equivalent state machine models that may be used to describe the desired operation of the interposer. Further, those skilled in the art will readily recognize variations to the state machine models described herein to provide for any number of hosts/controllers coupled to the associated SATA device. The state machine models described herein and depicted in FIG. 4 are therefore intended as representative of one exemplary design.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

1. An interposer for coupling multiple active storage controllers to a SATA storage device, the interposer comprising:
a multiplexer for selectively coupling SATA signals between the SATA storage devices and a selected storage controller of the multiple active storage controller; and
control logic coupled to the multiplexer for automatically controlling the multiplexer to select the selected storage controller.

2. The interposer of claim 1 wherein the multiplexer further comprises:
a receive signal multiplexer for selectively coupling a transmit signal from the selected storage controller to a receive signal path of the SATA storage device; and
a transmit signal multiplexer for selectively coupling a transmit signal from the SATA storage device to a receive signal path of the selected storage controller.

3. The interposer of claim 2 wherein the control logic further comprises:
an idle signal generator for generating an idle signal,
wherein the transmit signal multiplexer is operable to selectively couple the idle signal generator to all non-selected controllers of the multiple active storage controller to apply the idle signal to each of said non-selected controllers.

4. The interposer of claim 3 wherein the idle generator is adapted to generate ATA SYNC primitives to the non-selected controllers.

5. The interposer of claim 2 wherein the control logic further comprises:
a detector for detecting the initiation of a transfer by a requesting controller of the multiple active storage controller,
wherein the control logic is operable to select the requesting controller as the selected controller in response to detection of initiation of a transfer by the requesting controller.

6. The interposer of claim 1 further comprising:
buffers associated with each controller of the multiple active storage controllers and with the SATA storage device and coupled to the control logic for maintaining alignment of transferred information in conjunction with selection of the multiplexer by the control logic.

7. An interposer for selectively coupling a SATA storage device and a plurality of controllers, the interposer comprising:
detection means for detecting a request by a select controller of the plurality of controller to initiate a transfer to the storage device; and
multiplexing means responsive to the detection means for coupling the select controller to the storage device.

8. The interposer of claim 7 wherein the storage device has a transmit signal and a receive signal and wherein each controller of the plurality of controllers has a transmit signal and a receive signal, and
wherein the multiplexing means further comprises:
means for coupling the transmit signal of the select controller to the receive signal of the storage device; and
means for coupling the receive signal of the select controller to the transmit signal of the storage device.

9. The interposer of claim 8 further comprising:
idle generation means for generating SATA SYNC primitives,
wherein the multiplexing means further comprises:
means for coupling the receive signal of each non-selected controller of the plurality of controllers to the idle generation means.

10. The interposer of claim 9 wherein the idle generation means further comprises:
a plurality of SATA SYNC primitive generators each associated with a corresponding controller of the plurality of controllers.

11. The interposer of claim 7 wherein the detection means detects the request based on in-band SATA information from the select controller.

12. A storage system comprising:
a plurality of storage controllers;
a SATA storage device; and
an interposer coupled between the SATA storage device and each of the plurality of storage controllers for selectively coupling a selected controller of the plurality of storage controllers to the SATA storage device wherein the interposer is operable to select the selected controller based solely on in-band SATA information generated by the plurality of storage controllers.

13. The storage system of claim 12 wherein the interposer is coupled to a transmit signal of each controller of the plurality of storage controllers and to a transmit signal of the SATA storage device and to a receive signal of said each controller and to a receive signal of the SATA storage device.

14. The storage system of claim 13 wherein the interposer further comprises:
a device buffer coupled to the receive signal of the SATA storage device; and
a plurality of controller buffers each coupled to the receive signal of a corresponding controller of the plurality of storage controllers,
wherein the interposer is adapted to use the device buffer and the plurality of controller buffer to assure word alignment when selecting the selected controller.

15. The storage system of claim 12 wherein the interposer further comprises:
control logic operable in accordance with a state machine model responsive to detecting an I/O start event signifying the start of a transfer between the selected controller and the SATA storage device and responsive to detecting an I/O end event signifying the end of the transfer between the selected controller and the SATA storage device.

16. The storage system of claim 15 wherein the control logic is operable in accordance with the state machine modal and is further responsive to detecting an alternate request event signifying another storage controller attempting to start a transfer to the SATA storage device.

17. A method for selectively coupling multiple active storage controllers to a SATA device comprising the steps of:
a) detecting a request to start a transfer between a requesting controller of the plurality of storage controllers and the SATA storage device;
b) coupling the requesting controller to the SATA device; and
c) transmitting idle information to the plurality of storage controllers other than the requesting controller.

18. The method of claim 17 further comprising the steps of:
d) detecting the end of the transfer between the requesting controller and the SATA storage device; and
e) repeating steps a) through d).

19. The method of claim 17 wherein the step of detecting further comprises:
detecting the request based on in-band SATA information.

20. The method of claim 17 wherein the step of coupling further comprises the steps of:
coupling a receive signal of the storage devices to a transmit signal of the requesting controller;
coupling a transmit signal of the storage device to a receive signal of the requesting controller; and
coupling a transmit signal of an idle information generator to a receive signal of each non-requesting controller of the plurality of controllers.
